(19) United States
(12) Patent Application Publication
(10) Pub. No.: US 2014/0000046 A1
(43) Pub. Date: Jan. 2, 2014

(54) PIPELINE INSPECTION GAUGE EXTRACTOR

(71) Applicant: Matthew S. Laymon, Tulsa, OK (US)

(72) Inventor: Matthew S. Laymon, Tulsa, OK (US)

(21) Appl. No.: 13/538,760

(22) Filed: Jun. 29, 2012

(51) Int. Cl. F16L 45/00

(52) U.S. Cl. 15/104.062

(57) ABSTRACT

This extractor is a simple-to-use tool that aids in removing a pipeline inspection gauge (“pig”) from a pipeline. A standard hitch ball (or other protuberance) is affixed to the pig providing an attachment point for the extractor. Upon arrival of the pig into a receiver, the extractor is inserted into the receiver and centered over the pig's hitch ball. When pushed onto the hitch ball, the extractor's pulling bars are forced apart and out in angled pulling bar slots. Once the extractor's pulling bars pass the midpoint of the hitch ball, extension springs provide tension to the ends of the pulling bars urging them to slide closer together in the angled pulling bar slots. The angled pulling bar slots ensure the pulling bars are at their narrowest point and securely attached to the hitch ball when the extractor is pulled from the receiver thereby permitting pig removal.

### CROSS-REFERENCE TO RELATED APPLICATIONS

N/A

### STATEMENT REGARDING FEDERALLY SPONSORED RESEARCH OR DEVELOPMENT.

N/A

### THE NAMES OF THE PARTIES TO A JOINT RESEARCH AGREEMENT.

N/A

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC.

N/A

### BACKGROUND OF THE ART

1. Field of the Art

The present art relates generally to extraction devices. More particularly, the present art relates to pipeline inspection gauge extraction devices.

2. Description of Related Art

Related art may be found in, but not necessarily limited to, the following US classifications: 15/104.062, 15/104.061, 15/104.001.

### BRIEF SUMMARY OF THE PIPELINE INSPECTION GAUGE EXTRACTOR

This extractor is a simple-to-use tool that aids in removing a pipeline inspection gauge (“pig”) from a pipeline. A standard hitch ball (or other protuberance) is affixed to the pig providing an attachment point for the extractor. Upon arrival of the pig into a receiver, the extractor is inserted into the receiver and centered over the pig's hitch ball (or other protuberance). When pushed onto the hitch ball (or other protuberance), the extractor's peripatetic rods are forced apart and out in angled rod slots. Once the extractor's peripatetic rods pass the midpoint of the hitch ball (or other protuberance), extension springs provide tension to the ends of the peripatetic rods urging them to slide closer together in the angled rod slots. The angled rod slots ensure the peripatetic rods are at their narrowest point and securely attached to the hitch ball (or other protuberance) when the extractor is pulled from the receiver thereby permitting pig removal.

### BRIEF DESCRIPTION OF THE SEVERAL VIEWS OF THE DRAWINGS

A preferred embodiment of the pig extractor is described in detail below with reference to the attached drawing figures, wherein:

FIG. 1 illustrates a sectional side view of a pig extractor before coupling with a pig.

FIG. 2 illustrates a sectional side view of a pig extractor coupling with a pig.

FIG. 3 illustrates a sectional side view of a pig extractor coupled with a pig.

FIG. 4 illustrates an exploded view of a pig extractor.

FIG. 5 illustrates perspective views of a pig extractor in closed and open positions.

FIG. 6 illustrates additional perspective views of a pig extractor in closed and open positions.

FIG. 7 illustrates side views of a pig extractor in closed and open positions.

FIG. 8 illustrates sectional side views of a pig extractor in closed and open positions.

### DETAILED DESCRIPTION OF THE PIPELINE INSPECTION GAUGE EXTRACTOR

The embodiments discussed herein are merely illustrative of specific manners in which to make and use the pipeline inspection gauge extractor and are not to be interpreted as limiting the scope thereof.

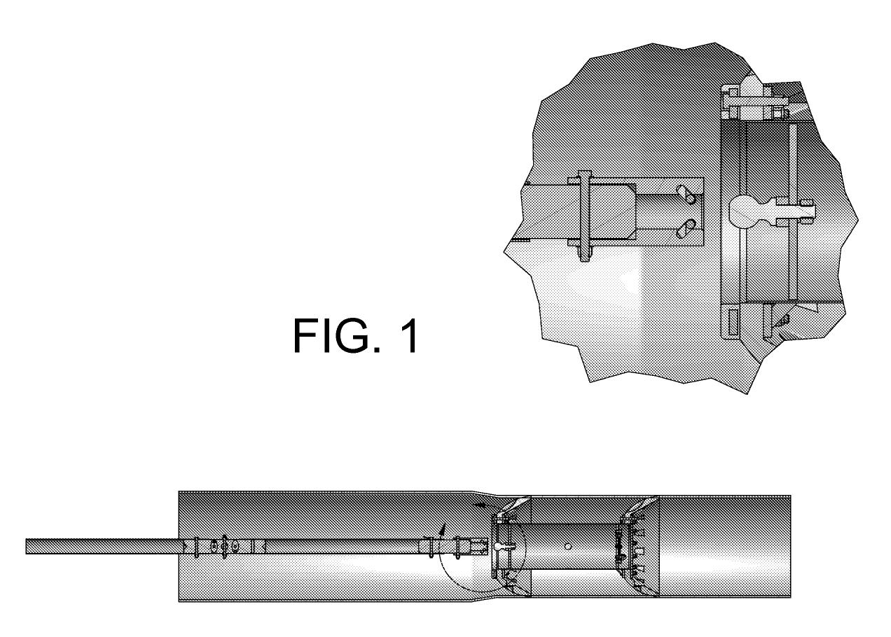

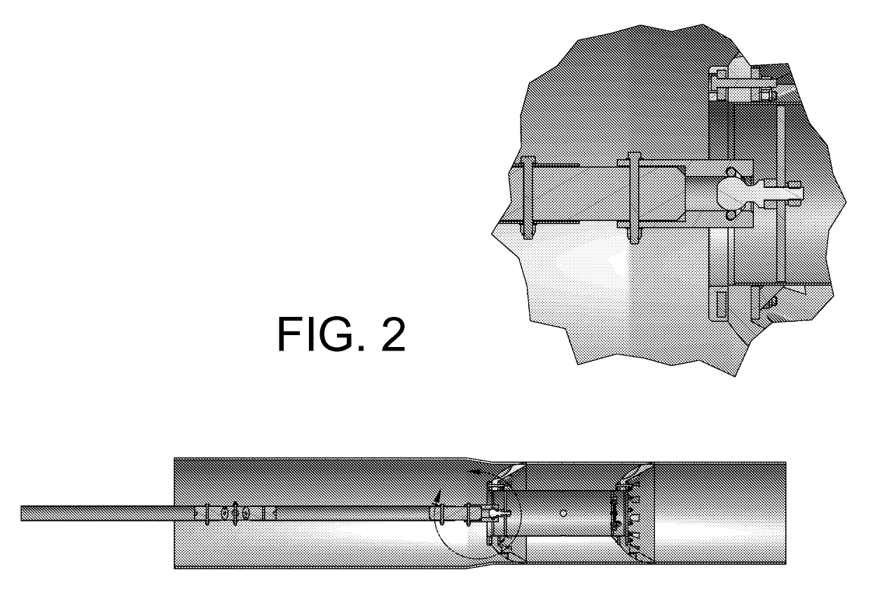

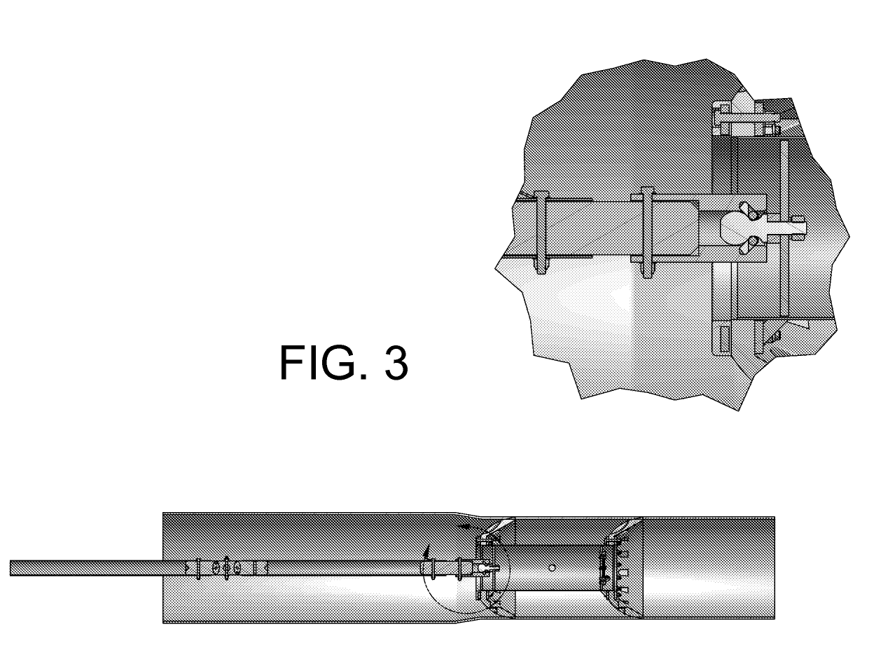

Referring to the drawings in detail, FIG. 1, FIG. 2, and FIG. 3 illustrate a pig extractor in the process of coupling with a pig that has entered a pipeline receiver. In FIG. 1, a pole with a pig extractor affixed to the end thereof is inserted into the pipeline receiver and near the pig while extension springs maintain the pig extractor's peripatetic rods in a closed position in the angled rod slots. In FIG. 2, the pig extractor is urged onto a protuberance located on the pig thereby forcing the pig extractor's peripatetic rods into an open position in the angled rod slots. In FIG. 3, the pig's protuberance is fully inserted into the pig extractor; upon clearing the rear of the protuberance, extension springs pull the pig extractor's peripatetic rods to a closed position in the angled rod slots thereby allowing the pig to be pulled from the pipeline receiver. During removal, compression and tension between the pig's protuberance and the pig extractor's peripatetic rods maintains the peripatetic rods in a closed position thereby encouraging a resilient clasp with the protuberance.

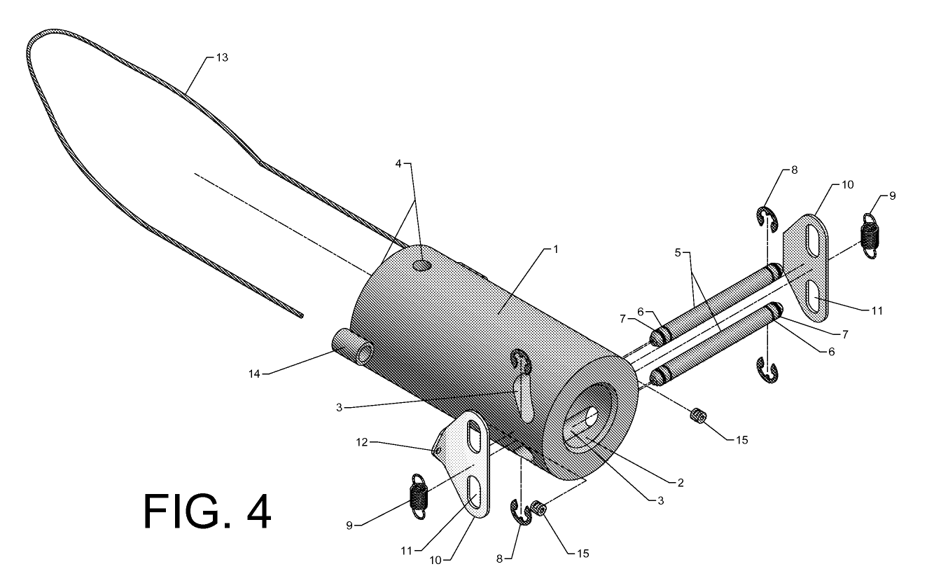

FIG. 4 illustrates an exploded view of a pig extractor. This embodiment includes a tube (1) with a coupling aperture (2) of sufficient size to allow the tube to couple with a pig's protuberance, angled rod slots (3), and apertures for attaching to a pole (4) or other reaching device. Inserted into the angled rod slots are two peripatetic rods (5) that include snap ring grooves (6) and spring groves (7) located on the ends thereof to permit the attachment of snap rings (8) and extension springs (9). Two cable plates (10) with elongated peripatetic rod apertures (11) and wire rope release holes (12) are positioned over each end of the peripatetic rods. The snap rings are installed to maintain the cable plates on the peripatetic rods and the extension springs are installed to urge the peripatetic rods in a closed position in the angled rod slots. The ends of a length of wire rope (13) may be inserted through two wire rope guides (14) located on the tube and attached to the cable plates via the wire rope release holes and two wire rope compression stop sleeves (15) that are attached to the wire rope ends after being inserted through the wire rope release holes. The wire rope can be pulled causing the cable plates to move along the tube thereby urging the peripatetic rods into an open position in the angled rod slots and allowing for the removal of the pig extractor from the pig's protuberance.

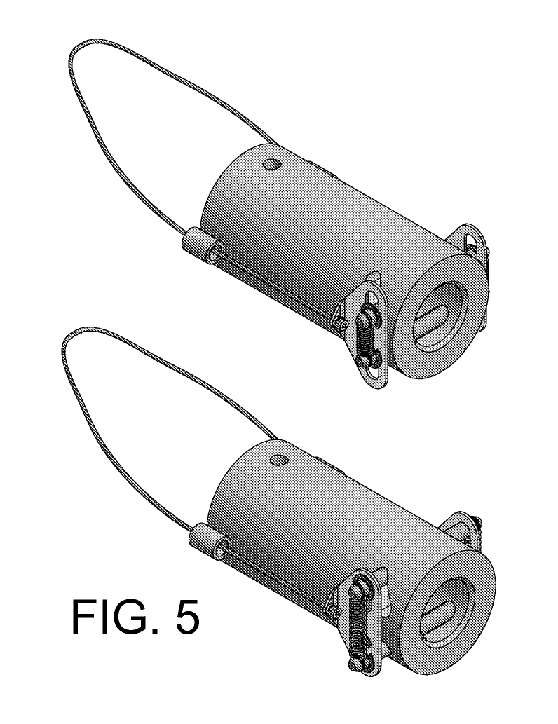

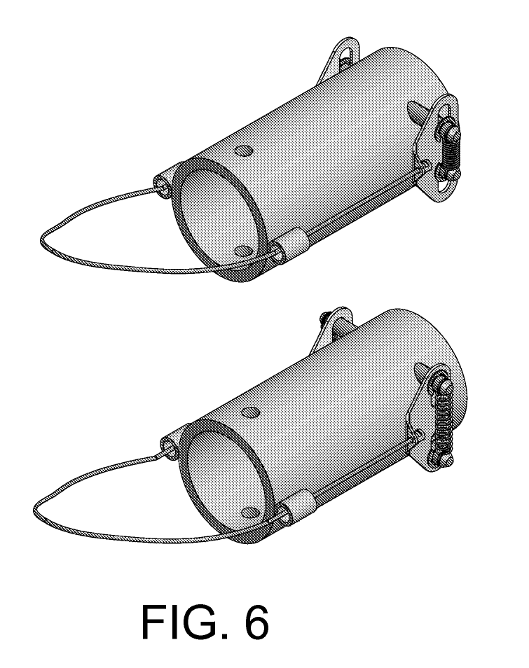

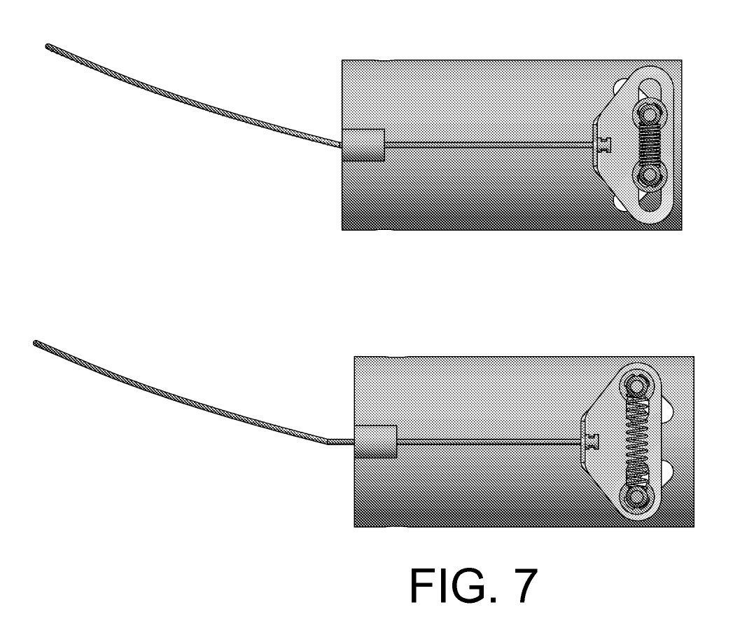

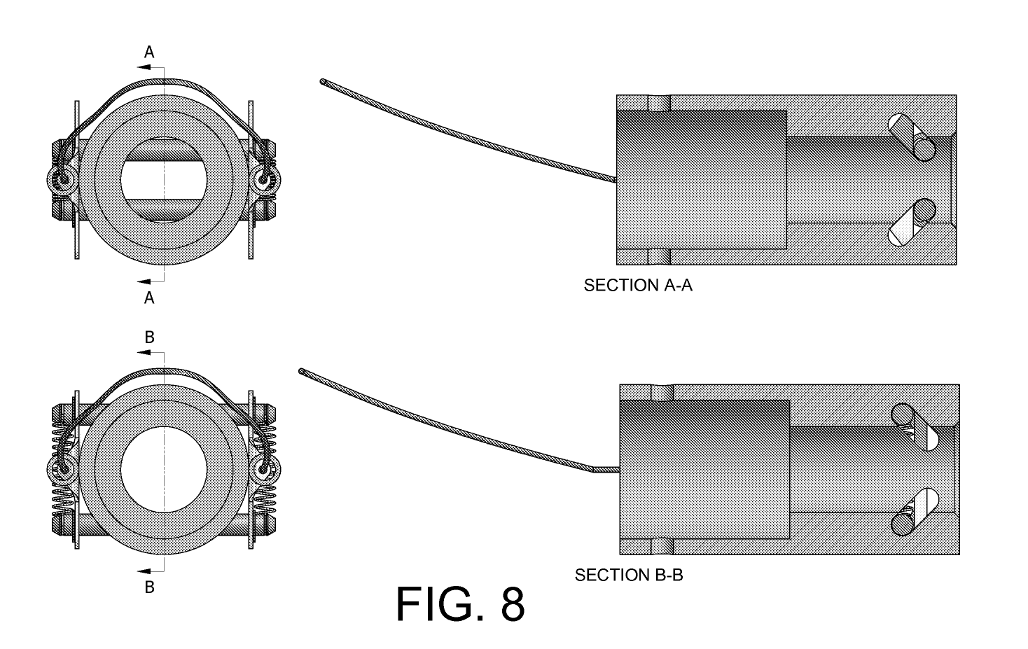

FIG. 5 through FIG. 8 illustrate various other views of the described embodiment of the pig extractor with peripatetic rods in both open and closed positions.

One skilled in the art can, without any experimentation, duplicate and create numerous variations of the pig extractor described herein by referencing the drawings and explanation herein. The tube may be formed from aluminum bar stock cut, drilled, and milled to the desired dimensions and with the desired features. The peripatetic rods may be formed from stainless steel bar stock cut and milled to the desired dimensions and with the desired features. The wire rope guides may be formed from aluminum tubing cut and milled to the desired dimensions and with the desired features. The cable plates may be formed by stamping aluminum plate stock to the desired dimensions and with the desired features. The snap rings, extension springs, wire rope, and wire rope compression stop sleeves are standard parts that may be obtained from various suppliers.

While the pipeline inspection gauge extractor has been described with a certain degree of particularity, it is to be noted that modifications may be made in the details of the pipeline inspection gauge extractor's construction and the arrangement of its components without departing from the spirit and scope of this disclosure. It is understood that the pipeline inspection gauge extractor is not limited to the embodiments set forth herein for the purposes of exemplification.

What is claimed is:

1. An apparatus comprising:
a. a first coupling implement with a protuberance located thereon;
b. a second coupling implement including:
i. an aperture of sufficient size to couple with the protuberance of said first coupling implement;
ii. at least two slots bisecting said aperture;
iii. two peripatetic rods coupled with said slots;
iv. means for maintaining said peripatetic rods in a close position when coupled with said protuberance of said first implement.

2. The apparatus of claim 1, further comprising:
a. means for alternately selectively shifting said peripatetic rods from a close position to an open position.

3. The apparatus of claim 1, further comprising:
a. means for detachably attaching said second coupling implement to an extension implement.

4. An apparatus comprising:
a. a first coupling implement with a protuberance located thereon;
b. a second coupling implement including:
i. an aperture of sufficient size to couple with the protuberance of said first coupling implement;
ii. at least two slots bisecting said aperture;
iii. two peripatetic rods coupled with said slots;
iv. means for maintaining said peripatetic rods in a close position when coupled with said protuberance of said first implement.
c. means for alternately selectively shifting said peripatetic rods from a close position to an open position;
d. means for detachably attaching said second coupling implement to an extension implement.
